(19) United States
(12) Patent Application Publication
(10) Pub. No.: US 2022/0326352 A1
(43) Pub. Date: Oct. 13, 2022

(54) LIDAR DEVICE INCLUDING A CURVED LENS ARRAY FOR EMITTING SUBBEAMS

(71) Applicant: Robert Bosch GmbH, Stuttgart (DE)

(72) Inventor: Johannes Richter, Ludwigsburg (DE)

(21) Appl. No.: 17/642,664

(22) PCT Filed: Oct. 23, 2020
(86) PCT No.: PCT/EP2020/079921

§ 371 Date: Mar. 11, 2022

(30) Foreign Application Priority Data
Oct. 31, 2019 (DE) 10 2019 216 809.4

(51) Int. Cl. G01S 7/481; G01S 17/08; G02B 27/12; G02B 3/00

(52) U.S. Cl. CPC G01S 7/4811; G01S 17/08; G02B 27/123; G02B 3/0043

(57) ABSTRACT

A LIDAR device for sampling a sampling range. The LIDAR device includes an emitting unit including at least one beam source for generating electromagnetic beams, and includes a receiving unit including at least one detector for receiving beams backscattered and/or reflected from the sampling range, the emitting unit and/or the receiving unit being immovable, rotatable or pivotable. The emitting unit includes a curved lens array for splitting the beams generated by the beam source into subbeams and for emitting the subbeams into the sampling range. A method for operating a LIDAR device including at least one curved lens array is also described.

The present invention relates to a LIDAR device for sampling a sampling range, including an emitting unit including at least one beam source for generating electromagnetic beams and including a receiving unit including at least one detector for receiving beams backscattered and/or reflected from the sampling range. The present invention furthermore relates to a method for operating a LIDAR device including at least one curved lens array.

### BACKGROUND INFORMATION

Vehicles and driving functions which are operable in an automated manner are increasingly gaining in importance on public roads. Sensors, such as for example camera sensors, radar sensors, and LIDAR sensors are necessary for the technical implementation of such vehicles and driving functions.

In the process, LIDAR sensors generate electromagnetic beams, for example laser beams, and utilize these beams for sampling a sampling range. Based on a time-of-flight analysis, distances between the LIDAR sensor and objects in the sampling range may be ascertained. For automated driving functions, LIDAR sensors including a sampling rate of more than 1 million points per second are necessary. For sampling objects at a distance of 300 meters, however, a measuring duration of at least two microseconds is required. When using so-called frequency-modulated continuous wave, or FMCW, LIDAR sensors, a measuring duration of up to ten microseconds is required. The measuring duration thus limits the maximum possible sampling rate of the LIDAR sensor.

Pulsed LIDAR sensors including multiple beam sources are conventional. For FMCW LIDAR sensors, however, this procedure is associated with considerable cost expenditure since frequency-modulated laser sources represent a major cost factor.

### SUMMARY

An object of the present invention is to provide a LIDAR device which allows multiple collimated beams to be emitted with a used beam source.

This object may achieved in accordance with the present invention. Advantageous example embodiments of the present invention are disclosed herein.

According to one aspect of the present invention, a LIDAR device for sampling a sampling range is provided. The LIDAR device includes an emitting unit including at least one beam source for generating electromagnetic beams and a receiving unit including at least one detector for receiving beams backscattered and/or reflected from the sampling range.

The emitting unit and/or the receiving unit is/are preferably designed to be immovable, rotatable or pivotable. According to an example embodiment of the present invention, the emitting unit includes a curved lens array for splitting the generated beams into subbeams and for emitting the subbeams into the sampling range.

The at least one beam source may preferably be a laser, an LED, and the like. In particular, the at least one beam source may be a frequency-modulated beam source including a small divergence so that the generated beams are collimated.

As a result of the use of the curved lens array, the collimated beams may be split into multiple subbeams, which are also collimated per se and thus enable a maximum sampling range. It is thus possible to provide multiple separate and slightly diverging subbeams for sampling a spatial sampling range. Due to the option of dividing a collimated beam into multiple subbeams, the number of beam sources used in the LIDAR device may be minimized, and the sampling rate or the number of available subbeams for sampling the sampling range may be increased. The subbeams are emitted at different sampling angles into the sampling range as a function of a radius of curvature of the curved lens array.

Depending on the configuration of the curved lens array, the generated beams may strike the curved lens array in collimated form, or may be focused onto the curved lens array or diverged in advance by an upstream optical element.

The curved lens array includes a curved carrier surface including at least two lenses. For example, the curved lens array may be manufactured with the aid of three-dimensionally printed casting molds or using Langmuir-Blodgett deposition.

The receiving unit of a LIDAR device may usually be designed to be less expensive than the emitting unit, so that multiple detectors may be used. The receiving unit may also include a curved lens array in the process, which is able to receive the beams backscattered and/or reflected from the sampling range and guide them onto the one or multiple detector(s).

Depending on the design of the LIDAR device, the emitting unit and the receiving unit may use a shared curved lens array, or may each include an emit-side and a receive-side curved lens array.

The use of a curved lens array is furthermore advantageous with respect to the modularity of the LIDAR device. In particular, defined operating parameters, such as for example resolution, number of subbeams for sampling, initial sampling angle without additional movement of the emitting unit, may be set by the used curved lens array, and may also be subsequently changed by replacing the curved lens array. In this way, the component diversity is reduced, and the manufacturing costs of the LIDAR device are lowered.

The LIDAR device is not limited to the use of frequency-modulated continuous wave LIDAR sensors. In particular, the LIDAR device according to the present invention including the curved lens array may be used with arbitrary beam sources and functional principles.

Furthermore, the curved lens array enables a parallelization of measurements, the resulting subbeams being collimated, and thus suitable for FMCW LIDAR measurements. Furthermore, it is possible to generate more subbeams for a higher sampling rate.

As a result of the use of a beam source, the produced lost heat and the manufacturing costs of the LIDAR device may be minimized.

In addition, the LIDAR device may be used as a sampling LIDAR device, or as a so-called flash LIDAR without movable components.

According to one exemplary embodiment of the present invention, the curved lens array includes at least two lenses, which are configured as microlenses or macrolenses. In this way, differently configured lenses may be used for the curved lens array. In particular, a maximum possible number of lenses per lens array, and thus also the highest possible resolution of the LIDAR device, may be set by the selection of a lens size.

According to another specific embodiment of the present invention, the lenses of the curved lens array are integrated into a spherical carrier structure or situated at the spherical carrier structure. As a result of this measure, the lenses may be situated on the carrier structure or be integrated into the carrier structure based on different manufacturing methods. For example, in the case of a casting method, the spherical carrier structure may be designed to be integral or in one piece with the lenses.

As an alternative, the lenses may be subsequently situated on a provided spherical carrier structure, for example with the aid of gluing.

According to another exemplary embodiment of the present invention, the lenses of the curved lens array have a focal length which corresponds to a radius of the spherical carrier structure. In this way, a radius of curvature of the spherical carrier structure or carrier surface may be set in such a way that a center of the spherical carrier structure agrees with the focal points of the lenses. For this purpose, the spherical carrier structure may be configured as a semi-circle having a defined radius.

As an alternative, the carrier structure may be configured as a semi-circular segment. Furthermore, an aspherically shaped carrier structure is also usable.

By setting the focal length of the lenses corresponding to the radius of the carrier structure, the beams which are guided onto the curved lens array may be divided into multiple subbeams and, at the same time, be collimated by the lenses. In the process, the respective subbeams differ in an offset radiation angle.

According to another specific embodiment of the present invention, the lenses of the curved lens array have a diameter of 100 μm to 10 cm. In this way, it is possible to situate lenses having different dimensions on the spherical carrier structure. In this way, in particular, a flexibility results in the configuration of the curved lens array. Similarly to the used diameter of the lenses, a corresponding adaptation of a size of the spherical carrier structure may take place. As a result of this measure, the curved lens array may be optimized with respect to compact dimensions of the LIDAR device and/or a light sensitivity. At the same time, the necessary limiting values for the intensity of the emitted beams or subbeams may be adhered to for ensuring the eye safety.

According to another exemplary embodiment of the present invention, the emitting unit includes at least two beam sources, which are configured to project generated beams in parallel to one another or via beam splitters onto the curved lens array. In particular, the different beam sources may be used for implementing a frequency modulation. For this purpose, the respective beam sources may emit beams having different wavelengths and/or having different pulse frequencies, an alternating activation of the respective beam sources being carried out. The beams generated by the beam sources may be coupled by the beam splitter into the beam path leading to the curved lens array.

According to another specific embodiment of the present invention, the generated beams may be beamed onto the curved lens array by at least one optical element. The optical element may, for example, be a concave or a convex lens. The optical element is used for acting on the generated beams, and thus changes the divergence of the generated beams, to enable an optimal interaction with the curved lens array.

In particular, the optical element may be designed in such a way that the subbeams emitted from the curved lens array are collimated. For this purpose, the optical element may align and collimate the generated beams into the curved lens array, or minimize their divergence, prior to an arrival.

According to another exemplary embodiment of the present invention, the receiving unit includes at least two detectors, which are situated in parallel to one another or at an angle with respect to one another. The angle of the detectors may, for example, be designed corresponding to the angle of the lenses on the spherical carrier structure to allow the beams reflected from the sampling range to strike optimally.

When a curved lens array is used in the reception path of the LIDAR device, the detector or detectors may be situated without an angular offset. In the process, a detector may also be a pixel of a planar detector, such as for example of a CMOS or CCD sensor.

According to another aspect of the present invention, a method for operating a LIDAR device according to the present invention including at least one curved lens array is provided. The curved lens array includes at least two lenses which are spaced apart from one another and which include optical axes rotated relative to one another. In particular, subbeams which have different radiation angles may thus be emitted. The maximum possible radiation angles may define an aperture angle of the curved lens array in the process.

To compensate for a radiation angle or an angular difference of the at least two lenses of the lens array, or to sample a larger sampling range compared to the aperture angle of the array, the emitting unit and/or the receiving unit is/are pivoted in at least one spatial direction. As a result of this measure, the sampling range and the resolution of the LIDAR device may be increased.

In particular, a minor movement of the emitting unit and/or of the receiving unit may be used to compensate for an angular difference of the respective lenses of the wedge-shaped lens array. As an alternative or in addition, the movement of the emitting unit and/or of the receiving unit may be expanded in such a way that a larger sampling range of the LIDAR device is sampled.

Preferred exemplary embodiments of the present invention are described in greater detail hereafter based on highly simplified schematic representations.

### BRIEF DESCRIPTION OF THE DRAWINGS

FIG. 1 shows a schematic representation of a LIDAR device according to one specific embodiment of the present invention.

FIG. 2 shows a detailed view onto emitted subbeams of a curved lens array, according to an example embodiment of the present invention.

FIG. 3 shows a schematic representation of an emitting unit of a LIDAR device according to another specific embodiment of the present invention.

### DETAILED DESCRIPTION OF EXAMPLE EMBODIMENTS

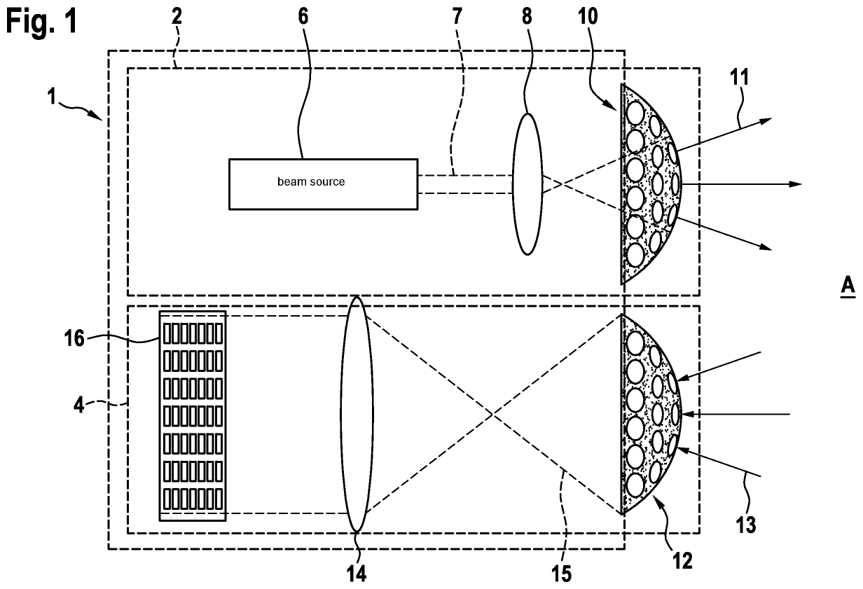

FIG. 1 shows a schematic representation of a LIDAR device 1 according to one specific embodiment of the present invention. LIDAR device 1 includes an emitting unit 2 and a receiving unit 4.

According to the illustrated exemplary embodiment, emitting unit 2 includes a beam source 6, which is configured as an infrared laser. Beam source 6 is used for generating electromagnetic beams 7. Emitting unit 2 furthermore includes an optical element 8 and a curved lens array 10.

Optical element 8 is configured as a convex lens and is situated between beam source 6 and curved lens array 10 in the beam path of the generated beams 7.

Curved lens array 10 is used to divide the generated beams 7 into multiple subbeams 11, which are emitted into a sampling range A.

Optical element 8 may diverge or focus the generated beams 7 in such a way that subbeams 11 emitted by curved lens array 10 are beamed into sampling range A in collimated form. In the process, subbeams 11 are emitted in different emission direction.

Receiving unit 4 also includes a curved lens array 12, which is configured to receive beams 13 reflected and/or backscattered from sampling range A.

The received beams 15 are subsequently focused by an optional reception optics 14 onto a detector 16. According to the exemplary embodiment, detector 16 is configured as a detector array.

Depending on the design of LIDAR device 1, emitting unit 2 and receiving unit 4 may each include a curved lens array 10, 12 or share or jointly use a single curved lens array.

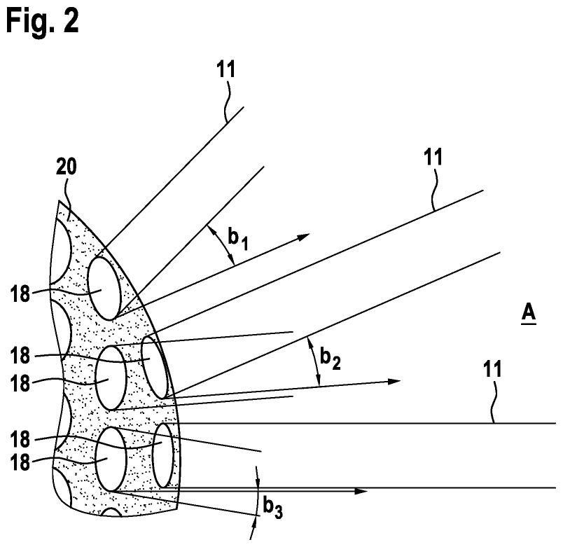

FIG. 2 shows a detailed view onto emitted subbeams 11 of curved lens array 10 of emitting unit 2. Curved lens array 10 includes a plurality of lenses 18, which are situated on a spherical carrier structure 20 or integrated into spherical carrier structure 20.

Lenses 18 may be configured as macrolenses or as microlenses. Lenses 18 are preferably adapted to spherical carrier structure 20 and to optical element 8 in such a way that subbeams 11 are emitted in collimated form into sampling range A. As a result, all sub-beams 11 of a lens 18 extend at an almost identical angle with respect to one another. Subbeams 11 of different lenses 18 may have different radiation angles b1 through b3.

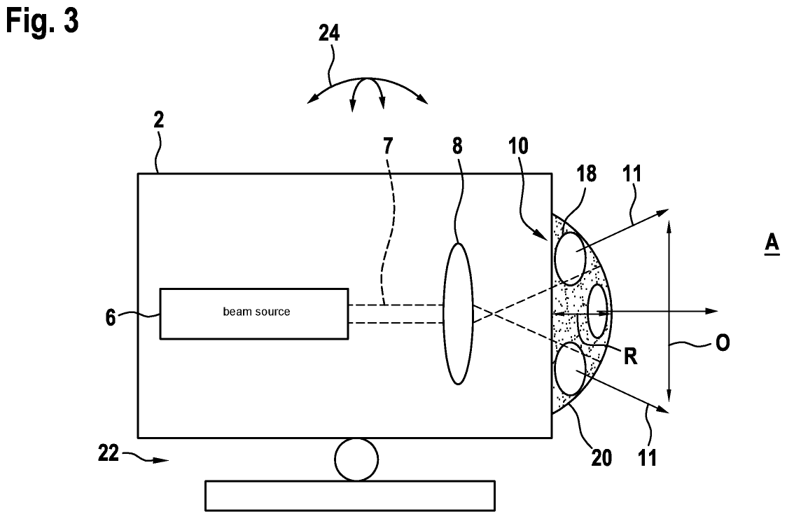

FIG. 3 shows a schematic representation of an emitting unit 2 of a LIDAR device 1 according to one further specific embodiment. In contrast to LIDAR device 1 shown in FIG. 1, emitting unit 2 includes a curved lens array 10 including larger configured macrolenses 18.

Lenses 18 preferably have an identical focal length, which corresponds to a radius R of spherical carrier structure 20.

Spherical carrier structure 20 is designed as a hemisphere and forms an emission window of emitting unit 2.

As a result of a lower number of lenses 18 compared to emitting unit 2 shown in FIG. 1, the number of subbeams 11 is also lower. To compensate for the lower number of subbeams 11, emitting unit 2 or the entire LIDAR device 1 may be situated on a pivoting mechanism 22, which may pivot emitting unit 2 in at least one spatial direction.

According to the exemplary embodiment, emitting unit 2 is pivotable about two axes. Arrows 24 illustrate the possible pivoting directions of emitting unit 2 by pivoting mechanism 22.

Curved lens array 10 has an aperture angle O, which is set by an arrangement of lenses 18. Aperture angle O is spanned by the emitted subbeams 11 and may be designed to be one-dimensional or two-dimensional.

Aperture angle O thus represents a maximum sampling angle of an immovable curved lens array 10. Through the use of pivoting mechanism 22, a maximum possible sampling angle of LIDAR device 1 may be increased.

1-10. (canceled)

11. A LIDAR device for sampling a sampling range, comprising:
an emitting unit including at least one beam source configured to generate electromagnetic beams; and
a receiving unit including at least one detector configured to receive beams backscattered and/or reflected from the sampling range,
wherein the emitting unit and/or the receiving unit is immovable, rotatable or pivotable;
wherein the emitting unit includes a curved lens array configured to split the beams generated by the beam source into subbeams and to emit the subbeams into the sampling range.

12. The LIDAR device as recited in claim 11, wherein the curved lens array includes at least two lenses, which are configured as microlenses or macrolenses.

13. The LIDAR device as recited in claim 12, wherein the lenses of the curved lens array are integrated into a spherical carrier structure or situated at the spherical carrier structure.

14. The LIDAR device as recited in claim 13, wherein the lenses of the curved lens array have a focal length which corresponds to a radius of the spherical carrier structure.

15. The LIDAR device as recited in claim 12, wherein the lenses of the curved lens array have a diameter of 100 μm to 10 cm.

16. The LIDAR device as recited in claim 11, wherein the receiving unit includes a curved lens array configured to receive beams backscattered and/or reflected from the sampling range.

17. The LIDAR device as recited in claim 11, wherein the emitting unit includes at least two beam sources, which are configured to project generated beams in parallel to one another or via beam splitters onto the curved lens array.

18. The LIDAR device as recited in claim 11, wherein the beams generated by the beam source are emitted onto the curved lens array by at least one optical element.

19. The LIDAR device as recited in claim 11, wherein the receiving unit includes at least two detectors which are situated in parallel to one another or at an angle with respect to one another.

20. A method for operating a LIDAR device including an emitting unit, a receiving unit, and the emitting unit including at least one curved lens array which includes at least two lenses spaced apart from one another, the method comprising:
pivoting the emitting unit and/or the receiving unit in at least one spatial direction to for compensating for a radiation angle of the at least two lenses or for sampling a larger sampling range compared to an aperture angle of the curved lens array.
